(19) United States
(12) Patent Application Publication
(10) Pub. No.: US 2025/0050873 A1
(43) Pub. Date: Feb. 13, 2025

(54) VEHICLE CONTROL SYSTEMS FOR VEHICLE DRIVING BEHAVIOR DETECTION AND AUTOMATED VEHICLE AVOIDANCE CONTROL

(71) Applicant: GM GLOBAL TECHNOLOGY OPERATIONS LLC, Detroit, MI (US)

(72) Inventors: Mehdi ABROSHAN, Waterloo (CA); Mohammadali Shahriari, Markham (CA); Hassan Askari, Thornhill (CA); Zhi Li, Unionville (CA)

(21) Appl. No.: 18/448,349

(22) Filed: Aug. 11, 2023

(51) Int. Cl. B60W 30/09; B60W 30/095; B60W 50/16

(52) U.S. Cl. CPC B60W 30/09; B60W 30/0956; B60W 50/16; B60W 2050/143; B60W 2050/146; B60W 2554/4046

(57) ABSTRACT

A vehicle control system for driving behavior vehicle detection includes at least one vehicle object detector configured to detect motion of target vehicles within an object detection range of a host vehicle, a vehicle user interface configured to display a visual indication to a driver of the host vehicle, and a vehicle control module configured to obtain detected motion parameters of the one or more target vehicles via the at least one vehicle object detector, determine a hazard index for each of the one or more target vehicles, according to the detected motion parameters, and in response to the hazard index exceeding a specified threshold value for at least one of the one or more vehicles, update the vehicle user interface to provide a visual notification of identified driving behavior exceeding the specified threshold value for the at least one of the one or more target vehicles.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle control systems for vehicle driving behavior detection, including automated vehicle avoidance control.

A current trend in the automotive industry is to introduce safety systems for avoiding or mitigating collisions. Some of the introduced safety systems, such as Forward Collision Avoidance Systems (FCAS), are aimed at avoiding or mitigating forward collisions between a vehicle hosting such a system and an oncoming vehicle. For example, vehicle object detectors such as cameras, lasers or lidar may be used to monitor vehicles on a road surrounding a host vehicle.

### SUMMARY

A vehicle control system for driving behavior vehicle detection and notification includes at least one vehicle object detector configured to detect motion of one or more target vehicles within an object detection range of a host vehicle, a vehicle user interface configured to display a visual indication to a driver of the host vehicle, and a vehicle control module configured to obtain detected motion parameters of the one or more target vehicles via the at least one vehicle object detector, determine a hazard index for each of the one or more target vehicles, according to the detected motion parameters, and in response to the hazard index exceeding a specified threshold value for at least one of the one or more vehicles, update the vehicle user interface to provide a visual notification of identified driving behavior exceeding the specified threshold value for the at least one of the one or more target vehicles.

In other features, each of the one or more target vehicles is displayed on the vehicle user interface, and the visual notification includes a highlight of the at least one of the one or more target vehicles on the vehicle user interface.

In other features, the vehicle control module is configured to generate at least one of an audible alert or a haptic seat feedback alert, in response to the hazard index exceeding a specified threshold value for at least one of the one or more target vehicles.

In other features, the vehicle control module is configured to identify, via the at least one vehicle object detector, at least one of the one or more target vehicles approaching from a rear of the host vehicle, in a lane adjacent to the host vehicle, and display a visual hazard indication in the lane adjacent to the host vehicle on the vehicle user interface.

In other features, the vehicle control module is configured to identify, via the at least one vehicle object detector, a lane adjacent to the host vehicle which is free of other vehicles, and display a visual clear lane indication in the lane adjacent to the host vehicle on the vehicle user interface.

In other features, the host vehicle includes an advanced driver-assistance system configured to control steering of the host vehicle, and the vehicle control module is configured to automatically execute a steering maneuver to move the host vehicle into the lane adjacent to the host vehicle, in response to identifying that the lane adjacent to the host vehicle is free of other vehicles.

In other features, the vehicle control module is configured to display a visual indication of a recommended lane change direction on the vehicle user interface, in response to identifying that the lane adjacent to the host vehicle is free of other vehicles.

In other features, the vehicle control module is configured to, for each of the one or more target vehicles, determine the hazard index according to at least one of a vehicle relative lateral acceleration, a vehicle longitudinal acceleration, a vehicle lane crossing index, a vehicle lane centering index, or a vehicle traffic rules violation index.

In other features, the vehicle control module is configured to, for each of the one or more target vehicles, determine the hazard index by combining weighted values of the vehicle relative lateral acceleration, the vehicle longitudinal acceleration, the vehicle lane crossing index, the vehicle lane centering index, and the vehicle traffic rules violation index.

In other features, the vehicle control module is configured to, for each of the one or more target vehicles, determine a driving behavior classification according to a weighted combination of the vehicle relative lateral acceleration and the vehicle longitudinal acceleration, and display a vehicle identifier on the vehicle user interface in response to the driving behavior classification exceeding a classification threshold value.

In other features, the vehicle control module is configured to, for each of the one or more target vehicles, determine a driving classification according to a weighted combination of the vehicle lane crossing index, the vehicle lane centering index, and the vehicle traffic rules violation index, and display a vehicle identifier on the vehicle user interface in response to the driving classification exceeding a classification threshold value.

In other features, the vehicle control system is configured to determine the vehicle relative lateral acceleration by monitoring lateral acceleration relative to a vehicle lane of travel, determine the vehicle lane crossing index by counting a number of occurrences of crossing a lane boundary of the vehicle lane of travel, determine the vehicle lane centering index by measuring an average vehicle distance a center of the vehicle lane of travel, and determine the vehicle traffic rules violation index by determining at least a degree of vehicle speeding with respect to a speed limit of the vehicle lane of travel.

In other features, the vehicle control module is configured to obtain an average number of determined vehicles exceeding the specified threshold value for a road portion during a specified period of time, and provide an indication of a level of vehicles exceeding the specified threshold value for the road portion on a navigation map of the vehicle user interface.

A method for driving behavior vehicle detection and notification includes detecting, via at least one vehicle object detector, driving motion parameters of one or more target vehicles within an object detection range of a host vehicle, determining a hazard index for each of the one or more vehicles, according to the detected driving motion parameters, and in response to the hazard index exceeding a specified threshold value for at least one of the one or more target vehicles, updating a vehicle user interface to provide a visual notification of identified driving behavior for the at least one of the one or more target vehicles, wherein the detected driving motion parameters include, for each of the one or more target vehicles within the object detection range of the host vehicle, a relative lateral acceleration of the target vehicle, a longitudinal acceleration of the target vehicle, a lane crossing index of the target vehicle, a lane centering index of the target vehicle, and a traffic rules violation index of the target vehicle.

In other features, the method includes displaying the one or more target vehicles on the vehicle user interface, and highlighting the at least one of the one or more target vehicles on the vehicle user interface.

16 In other features, the method includes generating at least one of an audible alert or a haptic seat feedback alert, in response to the hazard index exceeding the specified threshold value for at least one of the one or more target vehicles.

In other features, the method includes identifying, via the at least one vehicle object detector, at least one of the one or more target vehicles approaching from a rear of the host vehicle, in a lane adjacent to the host vehicle, and displaying a visual hazard indication in the lane adjacent to the host vehicle on the vehicle user interface.

In other features, the method includes identifying, via the at least one vehicle object detector, a lane adjacent to the host vehicle which is free of other vehicles, and displaying a visual clear lane indication in the lane adjacent to the host vehicle on the vehicle user interface.

In other features, the host vehicle includes an advanced driver-assistance system configured to control steering of the host vehicle, and the method includes automatically executing a steering maneuver to move the host vehicle into the lane adjacent to the host vehicle, in response to identifying that the lane adjacent to the host vehicle is free of other vehicles.

In other features, the method includes displaying a visual indication of a recommended lane change direction on the vehicle user interface, in response to identifying that the lane adjacent to the host vehicle is free of other vehicles

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle including a reckless vehicle detection and notification system.

FIG. 2 is a block diagram of an example driving behavior classification of the system of FIG. 1.

FIG. 3 is diagram illustrating example lane crossing determinations for the system of FIG. 1.

FIG. 4 is a flow chart depicting an example method for reckless vehicle detection and notification.

FIG. 5 an example human-machine interface (HMI) for reckless vehicle detection and notification.

FIG. 6 illustrates the example HMI of FIG. 5 with an identified hazard lane and a recommended evasive maneuver lane identified.

FIG. 7 illustrates the example HMI of FIG. 6 including a displayed turn recommendation and escape path.

FIG. 8 illustrates an example navigation map depicting routes with identified high and low reckless vehicle frequencies.

In the drawings, reference numbers may be reused to identify similar and/or identical elements.

### DETAILED DESCRIPTION

Some example embodiments include vehicle control systems and methods for categorizing driving behavior of vehicles surrounding a host vehicle, based on detected driving motion of the surrounding vehicles, in order to determine an associated reckless driving risk level of the surrounding vehicles and execute recommended evasive driving actions for avoiding collisions. For example, a hazard index may be quantified for each surrounding vehicle, which systematically categorizes identified vehicles having a hazard index exceeding the specified threshold, to increase safety for the host vehicle.

The driver of the host vehicle may be informed about detected vehicles exceeding a specified threshold of the hazard index using, e.g., augmented reality, a vehicle user interface of a dashboard, warnings associated with each identified target surrounding vehicle based on the through the hazard index, etc. In addition, a collective hazard index may be determined and assigned to areas or roads with high reckless vehicle detection frequencies (e.g., high frequencies of vehicle having a hazard index exceeding a specified threshold). This new index may be displayed or implemented in, e.g., a vehicle navigation system, to facilitate selection of a safest driving route avoiding those higher risk areas of encountering vehicles having a hazard index exceeding a threshold.

In some example embodiments, the vehicle control module may detect driving behavior of the neighboring vehicles, and categorize the neighboring vehicles into different types, such as identified aggressive driving vehicles, identified distracted driving vehicles, etc. For example, object detection sensors of the host vehicle (such as cameras, lasers, lidar, etc.) may be monitor driving motion parameters of each surrounding vehicle, to identify harsh lateral and/or longitudinal acceleration/deceleration of surrounding vehicles, lane touching or crossing, not complying traffic rules and regulations, etc., to determine driving behaviors. These categories, and/or an overall hazardous driving index, may be utilized by the vehicle control module to plan a suitable evasive driving response.

In various implementations, the vehicle control module may warn the driver once a reckless vehicle is detected (e.g., a vehicle having a hazard index above a specified threshold), which may occur when ADAS features are not engaged. In order to advise the driver, the identified vehicle may be labeled, colored, highlighted, etc., such as using augmented reality or displaying a visual indication on a vehicle user interface, to help the driver recognize the identified vehicle on the road. Also, a recommended driving maneuver may be suggested based on an assessment by the vehicle control module of road and traffic conditions (such as identifying a lane adjacent to the host vehicle which is free of other vehicles).

The driver may be informed of an identified vehicle when ADAS features are engaged. In this situation, the driver may be informed about a planned maneuver that the ADAS feature is about to take in order to avoid the identified vehicle, such as by showing a visual indication of the planned driving maneuver using augmented reality or a visual notification on a vehicle user interface.

In some example embodiments, an escape lane may be highlighted (e.g., in green) and suggested to the driver, and a lane that is occupied (e.g., due to another vehicle in the lane) may highlighted to warn the driver in another color, such as a red lane identifier.

In various implementations, an index may be assigned to areas or roads that have a high frequency of detected reckless driving vehicles collected over time. For example, higher levels of vehicles exceeding a hazard index threshold value may be detected for roads which are currently undergoing road construction, which have inappropriate lane markings, etc. This index may be embedded into a car navigation system to choose a planned driving path to a destination with increased or maximum safety.

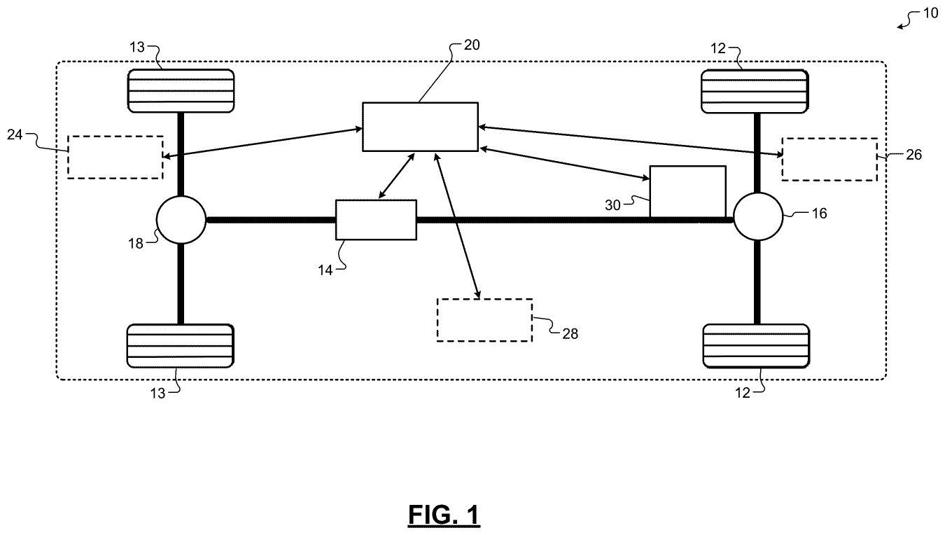

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.).

As shown in FIG. 1, the vehicle 10 includes an optional rear object detector 24, an optional front object detector 26, and an optional side object detector 28. In various implementations, the vehicle 10 may include more or less (or none) of any one of these optional sensors. Each object sensor may include any suitable camera, laser, lidar sensor, etc., which is used to detect objects around the vehicle 10, such as other target vehicles in within an object detection range of the vehicle 10. The object detection range may include a threshold accuracy range of a laser or lidar sensor, an accuracy range of a view of a camera, etc. In some example embodiments, a vehicle object detector may be configured to detect a closest in-path vehicle (CIPV) (e.g., another vehicle in front of a current driving path of the vehicle 10), a vulnerable road user (VRU) (e.g., a pedestrian or cyclist), etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks.

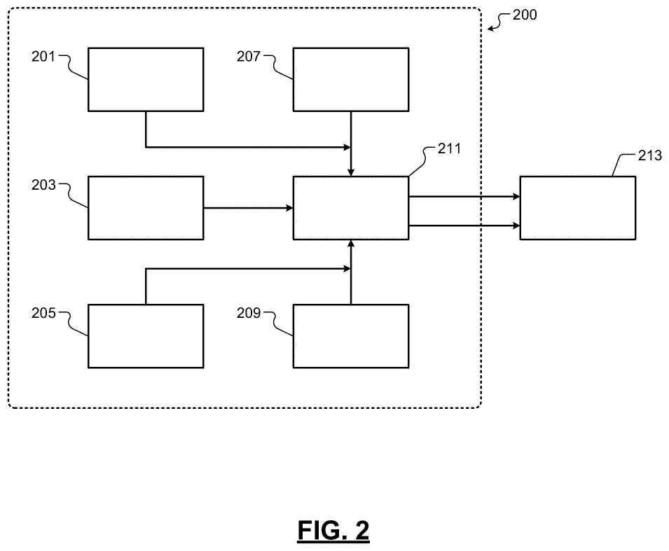

FIG. 2 is a block diagram of an example driving behavior classification 200 of the system of FIG. 1. As shown in FIG. 2, the driving behavior classification 200 may be executed by, for example, the vehicle control module 20 of FIG. 1, in order to determine whether a target vehicle around the host vehicle (e.g., in an adjacent lane of the host vehicle, behind or in front of the host vehicle, etc.), is exhibiting reckless driving behavior. The host vehicle may refer to a vehicle which includes the vehicle control module and the vehicle object detectors for sensing motion of other target vehicles on a same road as the host vehicle.

The driving behavior classification 200 may be used to determine a reckless driving index for a target vehicle. For example, the driving behavior classification 200 may receive driving motion parameters of another target vehicle from the vehicle object detectors, and calculate separate driving behavior indices which are combined by a classifier 211 to determine an overall hazard index (e.g., a reckless driving index) for the target vehicle.

As shown in FIG. 2, the driving behavior classification 200 may include a lane touching/crossing index 201, a longitudinal acceleration index 203, a relative lateral acceleration index 205, a lane centering index 207, and a traffic rules violation index 209. The classifier 211 may calculate a weighted combination of the lane touching/crossing index 201, the longitudinal acceleration index 203, the relative lateral acceleration index 205, the lane centering index 207, and the traffic rules violation index 209. Other example embodiments may use more or less (or different) driving motion parameters, in order to classify reckless driving behavior.

The weighted combination may be compared to a specified threshold, to determine whether a target vehicle should be identified as exhibiting reckless driving behavior. The classifier 211 may transmit a reckless driving determination to a driver human-machine interface (HMI) of the vehicle 10, in order to display a visual notification highlighting the identified vehicle, based on the transmitted reckless driving determination according to the hazard index.

In some example embodiments, the lane touching/crossing index 201 may be calculated by detecting a lane touching/crossing occurrence of a target vehicle via an object detector, and maintaining a count of the number of occurrences in a specified timer period (e.g., within one minute, within five minutes, within an hour, etc.).

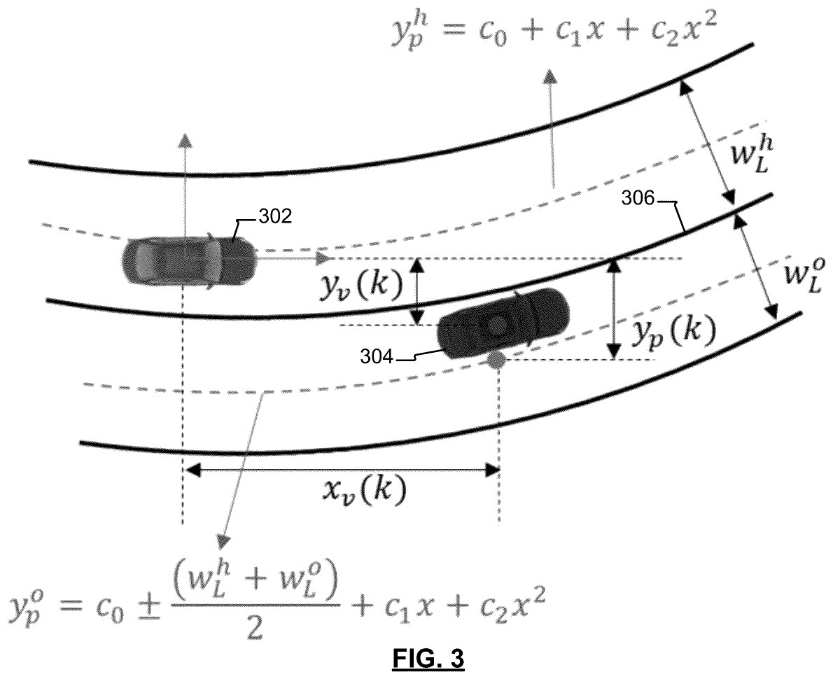

FIG. 3 is diagram illustrating example lane crossing determinations for the system of FIG. 1. As shown in FIG. 3, a host vehicle 302 includes one or more object detectors to determine lane touching/crossing events of a target vehicle 304. The object detector of the host vehicle 302 may be configured to determine whether the target vehicle 304 touches or crosses over the lane line 306 (or any other suitable road center lines or lane lines).

The vehicle control module 20 may process object detector data to perform example calculations illustrated in FIG. 3. For example, the vehicle control module may be configured to execute the following lane touching/crossing equations:

$$d ( k ) = {y}_{p}^{o} ( k ) - {y}_{v} ( k )$$

$${y}_{p}^{o} ( k ) = {y}_{p}^{o} ( x = {x}_{v} ( k ) )$$

$$\{ \begin{matrix}If ( \vert d ( k ) \vert + \frac{{w}_{obj}}{2} - ε > \frac{{w}_{L}^{o}}{2} ) \&\& T ( k - 1 ) \neq 1 & T ( k ) = 1 \\ & \end{matrix}$$

$$else \qquad T ( k ) = 0$$

$${N}_{LC} = {\sum }_{k = 1}^{n} T ( k )$$

where n is a buffer size, w_{obj} is a vehicle width, w_{L}^{o} is a lane width, ε is a slack variable, T(k) is a threshold, and N_{LC} is a is a count of lane touching/crossing events.

The longitudinal acceleration index 203 may be calculated using any suitable longitudinal acceleration algorithm. An example algorithm includes the following equations:

$${v}_{x}^{o} ( k ) = \frac{{x}^{o} ( k ) - {x}^{o} ( k - 1 )}{dt}$$

$${a}_{x}^{o} ( k ) = \frac{{v}_{x}^{o} ( k ) - {v}_{x}^{o} ( k - 1 )}{dt}$$

$${A}_{x}^{idx} = \frac{{\sum }_{k = 1}^{m} \vert {a}_{x}^{o} ( k ) \vert}{{a}_{x}^{max} \times m}$$

where m is a moving average window size, aₓ^{max} is a maximum longitudinal acceleration, and dt is a sampling time.

The relative lateral acceleration index 205 may be calculated using any suitable lateral acceleration algorithm for determining lateral acceleration of a target vehicle, such as lateral acceleration relative to a lane of the target vehicle. An example algorithm includes the following equations:

$${v}_{y}^{o} ( k ) = \frac{d ( k ) - d ( k - 1 )}{dt}$$

$${a}_{y}^{o} ( k ) = \frac{{v}_{y}^{o} ( k ) - {v}_{y}^{o} ( k - 1 )}{dt}$$

$${A}_{y}^{idx} = \frac{{\sum }_{k = 1}^{m} \vert {a}_{y}^{o} ( k ) \vert}{{a}_{y}^{max} \times m}$$

wherein a_{y}^{max} is a maximum lateral acceleration.

The lane centering index 207 may be calculated using any suitable algorithm for determining, e.g., an average distance of a target vehicle from a center of its driving lane. An example algorithm includes the following equation:

$${D}^{idx} = \frac{2 {\sum }_{k = 1}^{m} \vert d ( k ) \vert}{{w}_{L}^{o} \times m}$$

The traffic rules violation index 209 may be calculated using any suitable longitudinal acceleration algorithm for determining lateral acceleration of a target vehicle, such as lateral acceleration relative to a lane of the target vehicle. An example algorithm includes the following equation:

$${T}^{idx} = \frac{{\sum }_{k = 1}^{m} ( {v}_{x}^{o} - {v}_{x}^{max} )}{{v}_{x}^{max} \times m}$$

In some example embodiments, the various indices may be combined to generate an overall hazard index (e.g., a reckless driving index), which may include different weights for the parameters. An example hazard index equation includes:

$${H}_{idx} = {K}_{LC} \times {N}_{LC} + {K}_{ay} \times {A}_{y}^{idx} + {K}_{ax} \times {A}_{x}^{idx} + {K}_{D} \times {D}^{idx} + {K}_{T} \times {T}^{idx}$$

where K_{LC}, K_{ay}, Kₐₓ, K_{D}, and K_{T} are a weights set based on the impact of each index. If the hazard index is above a specified threshold value indicative of reckless driving behavior, the vehicle control model may determine to classify the target vehicle as a reckless driving vehicle (which may then be displayed on a vehicle user interface, etc.).

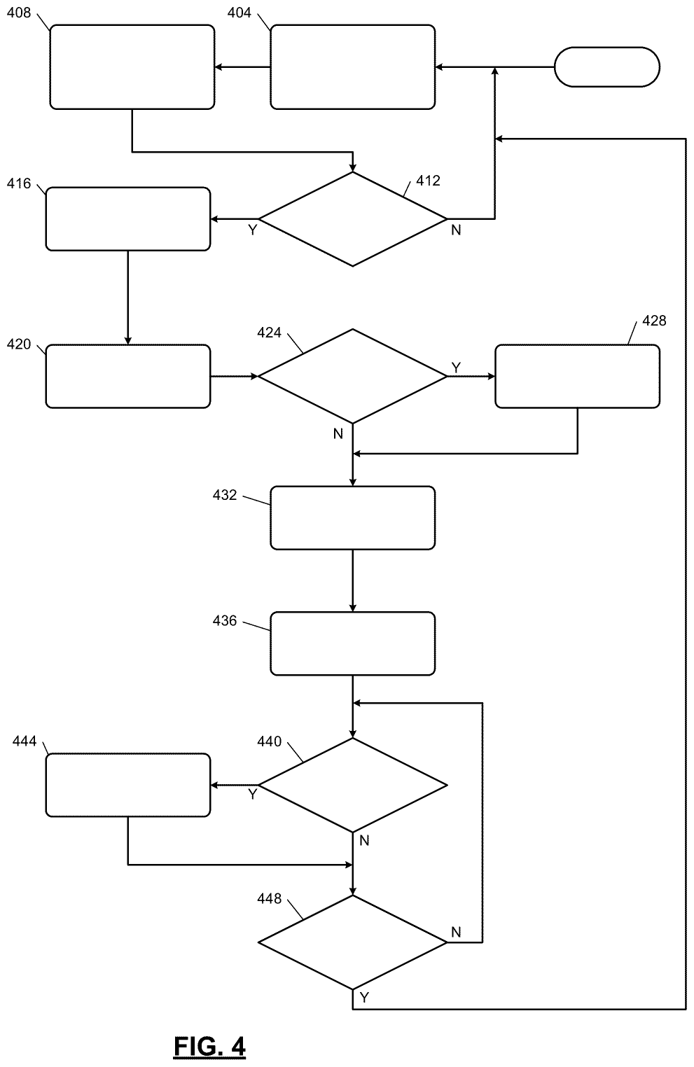

FIG. 4 is a flow chart depicting an example method for reckless vehicle detection and notification. The process may be performed by, for example, the vehicle control module 20 of FIG. 1. At 404, the process begins by obtaining driving characteristic parameters of other target vehicles in a vicinity of the host vehicle (e.g., within a vehicle object detection range of the host vehicle, etc.). The target vehicle driving characteristic parameters may be obtained via one or more vehicle object detectors of the host vehicle.

At 408, the vehicle control module is configured to generate a driving behavior classification index for each vehicle in the vicinity. Control then determines whether any of the target vehicles in the vicinity have a driving behavior index above the specified threshold value at 412.

If so, control proceeds to 416 to identify the vehicle in the HMI display (e.g., a vehicle user interface, dash display, windshield overlay, etc.). The identification may include a visual notification, highlighting of the identified vehicle (such as via a bounding box added to the display), an audible alert, a haptic seat vibration alert, etc.

At 420, control identifies whether any other vehicles are approaching the host vehicle from the rear in an adjacent lane. If any vehicles are approaching from the rear at 424, control displays a hazardous lane indicator at 428.

After displaying the hazardous lane indicator at 428, or if the vehicle control module determines at 424 that there are not any vehicles approaching from the rear, control proceeds to 432 to determine a recommended avoidance path. For example, the recommended avoidance path may include an adjacent lane where no other vehicles are currently detected.

At 436, control displays the recommended avoidance path on the vehicle HMI. At 440, the vehicle control module is configured to determine whether the vehicle is equipped with an advanced driver-assistance system (ADAS). If so, control initiates an automated steering maneuver to the recommended adjacent lane at 444. Once the identified vehicle has been avoided at 448 (e.g., when the identified reckless vehicle is no longer detected as within a specified distance of the host vehicle), control returns to 404 to obtain new driving characteristic parameters of other target vehicles in the vicinity of the host vehicle.

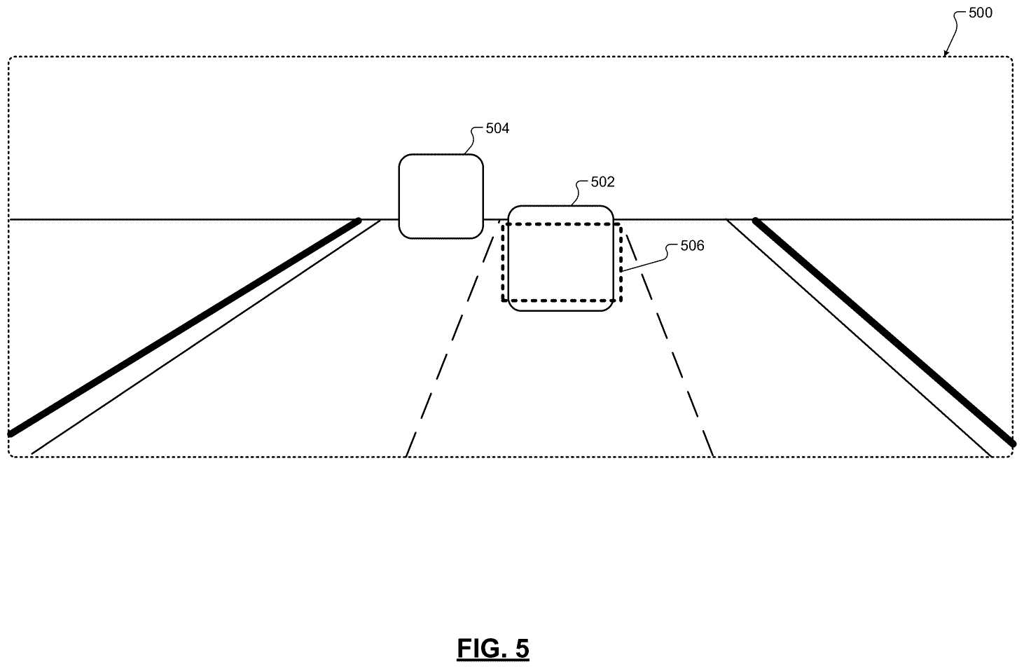

FIG. 5 an example human-machine interface (HMI) 500 for reckless vehicle detection and notification. As shown in FIG. 5, the HMI 500 shows a current driving path of the host vehicle, with lanes of the road displayed. The HMI 500 may be implemented, for example, in a dash of the host vehicle, projected onto a windshield of the vehicle, etc.

The HMI 500 displays an identified vehicle 502 having a hazard index value which exceeds a specified threshold, and an identified vehicle 504 which has a hazard index value below the specified threshold. For example, the vehicle 502 may have a hazard index value which is above a specified threshold indicative of reckless driving behavior (e.g., as determined by an object detector of the host vehicle sensing driving movement parameters of the vehicle 502). In some example embodiments, specified threshold may be normalized to one based on monitored vehicle parameters as described herein, may be set at a specific value based on measured and tested values of the various vehicle parameters with respect to driving behaviors interpreted as normal vehicle operation or operation that exceeds identified safe driving boundaries.

In contrast, the vehicle 504 may have a hazard index value which is below the specified threshold that is indicative of reckless driving behavior. The HMI 500 may highlight the identified vehicle 502 via any suitable visual notification, such as a bounding box 506.

For example, when an ADAS feature is not engaged, a Reckless Vehicle Alert (RVA) may alert the driver when a vehicle having a hazard index value above the specified threshold is identified around the host vehicle. FIG. 5 illustrates an example of how an identified vehicle is highlighted on the screen using augmented reality. The vehicle may be highlighted by, e.g., red water drop symbol, a dot square bounding box 506, etc. In addition, if a chiming alert system is enabled, a chiming sound with optional haptic alert may assist the driver to in recognizing potential safety concerns. A counter may be used to indicate a total number of identified reckless vehicles (e.g., a total number of vehicles exceeding a hazard index specified threshold).

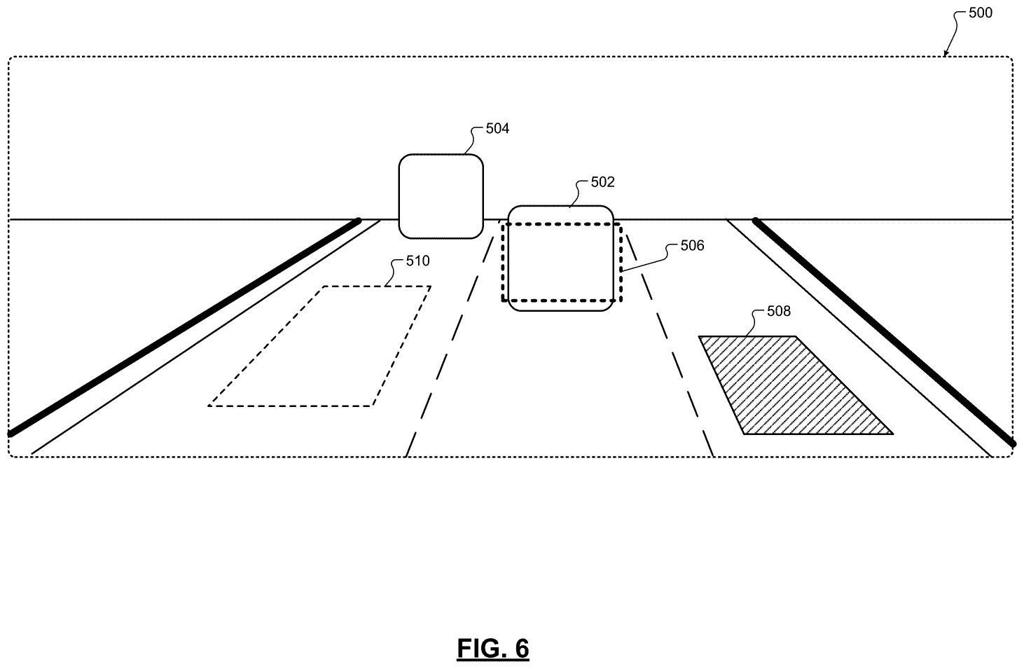

FIG. 6 illustrates the example HMI 500 of FIG. 5 with an identified hazard lane 508 and a recommended evasive maneuver lane 510 identified. For example, if the vehicle control module identifies that another vehicle is approaching the host vehicle from behind in an adjacent lane, the HMI 500 may identify the hazard lane 508 via, e.g., a red highlight, a do not enter box displayed on the lane, etc.

If the vehicle control module identifies an adjacent lane that is free of other vehicles (e.g., based on object detection sensors of the vehicle, etc.), a recommended evasive maneuver lane 510 may be identified on the HMI 500, such as by a green highlight, a free to enter box displayed on the lane, etc.

In some example embodiments, if an identified vehicle is behind the host vehicle, based on the position of the identified vehicle and its predicted maneuver, the safe and unsafe areas on the road (e.g., areas with vehicles exceeding or below the hazard index specified threshold), are highlighted green and red respectively to let the driver know best possible action that can be taken to avoid that reckless vehicle.

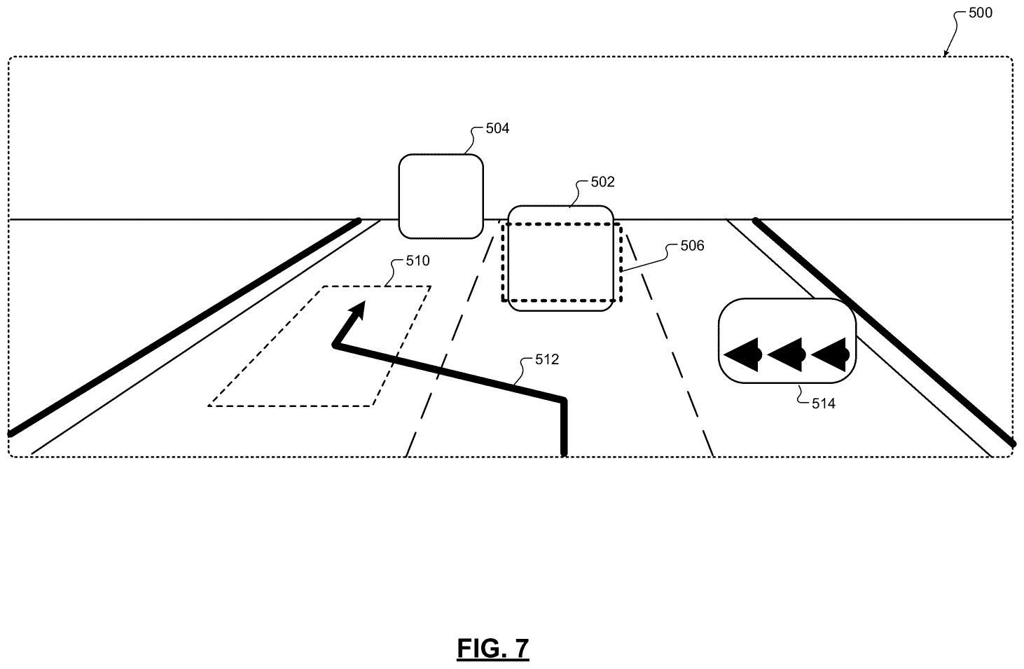

FIG. 7 illustrates the example HMI 500 of FIG. 6 including a displayed turn recommendation 514 and an escape path 512. For example, if the vehicle control module identifies an adjacent lane that is free of other vehicles (e.g., based on object detection sensors of the vehicle, etc.), the HMI 500 may display arrows for the turn recommendation 514 to show the driver a direction to turn to avoid the detected vehicle 502.

The HMI 500 may also display an escape path 512 to avoid the determined vehicle 502. The escape path 512 may illustrate a direction for the host vehicle to move into the recommended evasive maneuver lane 510.

For example, when an ADAS feature is engaged, the RVA may provide alert information and navigate a host vehicle to a safer operational area (e.g., the recommended unoccupied lane 510). As shown in FIG. 7, when two reckless vehicles are identified around the host vehicle (e.g., 1 in front of the host vehicle and 1 in rear), a planned trajectory may be generated to navigate host vehicle to the unoccupied region, as shown by the arrow. In this case, a lane change command may be performed with a chime and a haptic alert.

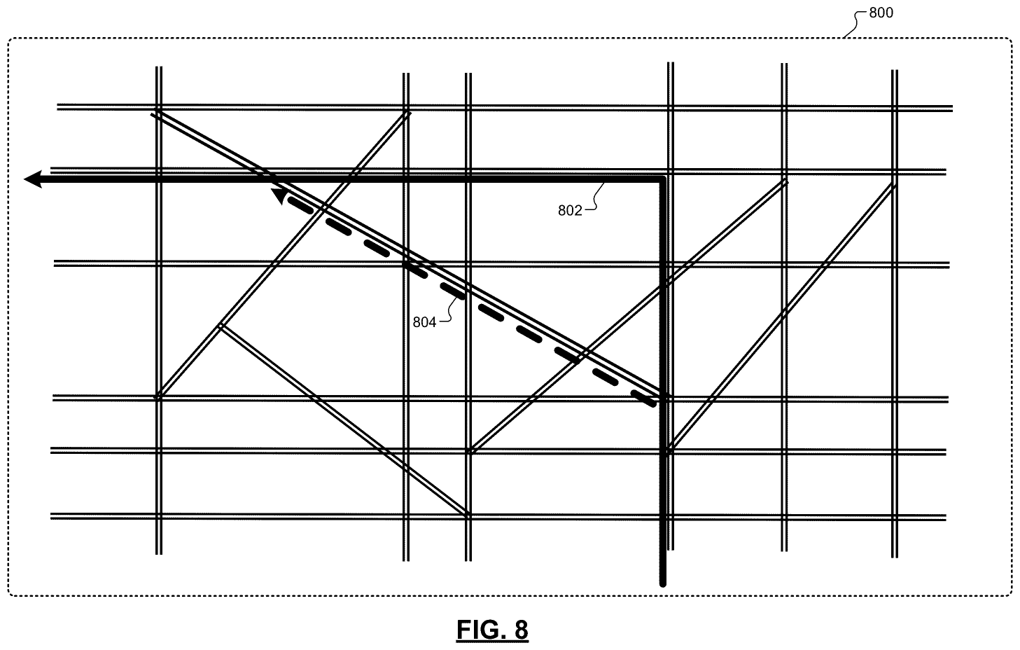

FIG. 8 illustrates an example navigation map 800 depicting routes with identified high and low reckless vehicle frequencies. For example, the navigation map 800 may be a navigation feature of the host vehicle, may be displayed on a vehicle user interface, may be used for GPS navigation or automated driving control, etc.

As shown in FIG. 8, a low reckless driver route 802 is illustrated as a solid line, while a high reckless driver route 804 is illustrated as a dotted line. For example, the vehicle control module may obtain data indicative of average numbers of detected reckless driving vehicles on various roads over specified time periods.

This information may be used to highlight to the driver which portions of roads in the area have a higher risk of encountering more identified reckless driving vehicles. In the example of FIG. 8, the navigation map 800 may warn the driver that taking the diagonal route 804 may have a higher risk of encountering reckless driving vehicles, compared to taking a different route 802 which has a lower frequency of reckless driving vehicles.

In some example embodiments, a Region Hazard Index (RHI) may be calculated to make drivers aware of roads having high frequencies of identified reckless driving vehicles, and optionally to route a navigation system around roads with a high threshold level of reckless driving within a specific region. The RHI may be calculated based on a number of recklessness triggers over a certain time period. An example equation below shows how the RHI may be calculated:

$$RHI = \frac{{\sum }_{i = 1}^{n} {R}_{tr}}{T}$$

In the above equation, R_tr is the recklessness hazard trigger, and i represents the number of detected reckless driving occurrences during time T (e.g., reckless driving occurrences that may be detected by other vehicles and transmitted to a central monitoring server, etc.).

Depending on the destination chosen by the driver, if the RHI is high in a region or for specific roads, a warning may be given to the driver, and the vehicle control module may be set to prepare for possible evasive driving maneuvers or recommendations if a detected reckless driving vehicle is encountered. The RHI may also be sent to the route navigation system to avoid the areas with high RHI when planning the driving route to the target destination for the host vehicle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle control system for driving behavior vehicle detection and notification, the vehicle control system comprising:
at least one vehicle object detector configured to detect motion of one or more target vehicles within an object detection range of a host vehicle;
a vehicle user interface configured to display a visual indication to a driver of the host vehicle; and
a vehicle control module configured to:
obtain detected motion parameters of the one or more target vehicles via the at least one vehicle object detector;
determine a hazard index for each of the one or more target vehicles, according to the detected motion parameters; and
in response to the hazard index exceeding a specified threshold value for at least one of the one or more vehicles, update the vehicle user interface to provide a visual notification of identified driving behavior exceeding the specified threshold value for the at least one of the one or more target vehicles.

2. The vehicle control system of claim 1, wherein:
each of the one or more target vehicles is displayed on the vehicle user interface; and
the visual notification includes a highlight of the at least one of the one or more target vehicles on the vehicle user interface.

3. The vehicle control system of claim 1, wherein the vehicle control module is configured to generate at least one of an audible alert or a haptic seat feedback alert, in response to the hazard index exceeding a specified threshold value for at least one of the one or more target vehicles.

4. The vehicle control system of claim 1, wherein the vehicle control module is configured to:
identify, via the at least one vehicle object detector, at least one of the one or more target vehicles approaching from a rear of the host vehicle, in a lane adjacent to the host vehicle; and
display a visual hazard indication in the lane adjacent to the host vehicle on the vehicle user interface.

5. The vehicle control system of claim 1, wherein the vehicle control module is configured to:
identify, via the at least one vehicle object detector, a lane adjacent to the host vehicle which is free of other vehicles; and
display a visual clear lane indication in the lane adjacent to the host vehicle on the vehicle user interface.

6. The vehicle control system of claim 5, wherein:
the host vehicle includes an advanced driver-assistance system configured to control steering of the host vehicle; and
the vehicle control module is configured to automatically execute a steering maneuver to move the host vehicle into the lane adjacent to the host vehicle, in response to identifying that the lane adjacent to the host vehicle is free of other vehicles.

7. The vehicle control system of claim 5, wherein the vehicle control module is configured to display a visual indication of a recommended lane change direction on the vehicle user interface, in response to identifying that the lane adjacent to the host vehicle is free of other vehicles.

8. The vehicle control system of claim 1, wherein the vehicle control module is configured to, for each of the one or more target vehicles, determine the hazard index according to at least one of a vehicle relative lateral acceleration, a vehicle longitudinal acceleration, a vehicle lane crossing index, a vehicle lane centering index, or a vehicle traffic rules violation index.

9. The vehicle control system of claim 8, wherein the vehicle control module is configured to, for each of the one or more target vehicles, determine the hazard index by combining weighted values of the vehicle relative lateral acceleration, the vehicle longitudinal acceleration, the vehicle lane crossing index, the vehicle lane centering index, and the vehicle traffic rules violation index.

10. The vehicle control system of claim 8, wherein the vehicle control module is configured to:
for each of the one or more target vehicles, determine a driving behavior classification according to a weighted combination of the vehicle relative lateral acceleration and the vehicle longitudinal acceleration; and
display a vehicle identifier on the vehicle user interface in response to the driving behavior classification exceeding a classification threshold value.

11. The vehicle control system of claim 8, wherein the vehicle control module is configured to:
for each of the one or more target vehicles, determine a driving classification according to a weighted combination of the vehicle lane crossing index, the vehicle lane centering index, and the vehicle traffic rules violation index; and
display a vehicle identifier on the vehicle user interface in response to the driving classification exceeding a classification threshold value.

12. The vehicle control system of claim 8, wherein the vehicle control system is configured to:
determine the vehicle relative lateral acceleration by monitoring lateral acceleration relative to a vehicle lane of travel;
determine the vehicle lane crossing index by counting a number of occurrences of crossing a lane boundary of the vehicle lane of travel;
determine the vehicle lane centering index by measuring an average vehicle distance a center of the vehicle lane of travel; and
determine the vehicle traffic rules violation index by determining at least a degree of vehicle speeding with respect to a speed limit of the vehicle lane of travel.

13. The vehicle control system of claim 1, wherein the vehicle control module is configured to:
obtain an average number of determined vehicles exceeding the specified threshold value for a road portion during a specified period of time; and
provide an indication of a level of vehicles exceeding the specified threshold value for the road portion on a navigation map of the vehicle user interface.

14. A method for driving behavior vehicle detection and notification, the method comprising:
detecting, via at least one vehicle object detector, driving motion parameters of one or more target vehicles within an object detection range of a host vehicle;
determining a hazard index for each of the one or more vehicles, according to the detected driving motion parameters; and
in response to the hazard index exceeding a specified threshold value for at least one of the one or more target vehicles, updating a vehicle user interface to provide a visual notification of identified driving behavior for the at least one of the one or more target vehicles,
wherein the detected driving motion parameters include, for each of the one or more target vehicles within the object detection range of the host vehicle, a relative lateral acceleration of the target vehicle, a longitudinal acceleration of the target vehicle, a lane crossing index of the target vehicle, a lane centering index of the target vehicle, and a traffic rules violation index of the target vehicle.

15. The method of claim 14, further comprising:
displaying the one or more target vehicles on the vehicle user interface; and
highlighting the at least one of the one or more target vehicles on the vehicle user interface.

16. The method of claim 14, further comprising generating at least one of an audible alert or a haptic seat feedback alert, in response to the hazard index exceeding the specified threshold value for at least one of the one or more target vehicles.

17. The method of claim 14, further comprising:
identifying, via the at least one vehicle object detector, at least one of the one or more target vehicles approaching from a rear of the host vehicle, in a lane adjacent to the host vehicle; and
displaying a visual hazard indication in the lane adjacent to the host vehicle on the vehicle user interface.

18. The method of claim 14, further comprising:
identifying, via the at least one vehicle object detector, a lane adjacent to the host vehicle which is free of other vehicles; and
displaying a visual clear lane indication in the lane adjacent to the host vehicle on the vehicle user interface.

19. The method of claim 18, wherein:
the host vehicle includes an advanced driver-assistance system configured to control steering of the host vehicle; and
the method includes automatically executing a steering maneuver to move the host vehicle into the lane adjacent to the host vehicle, in response to identifying that the lane adjacent to the host vehicle is free of other vehicles.

20. The method of claim 18, further comprising displaying a visual indication of a recommended lane change direction on the vehicle user interface, in response to identifying that the lane adjacent to the host vehicle is free of other vehicles.
